(19) United States
(12) Patent Application Publication
(10) Pub. No.: US 2016/0251833 A1
(43) Pub. Date: Sep. 1, 2016

(54) HYDRAULIC DRIVE SYSTEM OF CONSTRUCTION MACHINE

(71) Applicant: KAWASAKI JUKOGYO KABUSHIKI KAISHA, Kobe-shi, Hyogo (JP)

(72) Inventors: Akihiro KONDO, Nishinomiya-shi (JP); Makoto ITO, Kobe-shi (JP); Kazuto FUJIYAMA, Kobe-shi (JP)

(73) Assignee: KAWASAKI JUKOGYO KABUSHIKI KAISHA, Kobe-shi, Hyogo (JP)

(21) Appl. No.: 15/028,825

(22) PCT Filed: Oct. 10, 2014
(86) PCT No.: PCT/JP2014/005175

§ 371 Date: Apr. 12, 2016

(30) Foreign Application Priority Data
Oct. 31, 2013 (JP) 2013-226451

(51) Int. Cl. E02F 9/22; E02F 3/42; E02F 9/12; F15B 11/17; F15B 13/04

(52) U.S. Cl. CPC E02F 9/2235; F15B 11/17; F15B 13/0401; E02F 9/2292; E02F 9/2296; E02F 9/123; E02F 9/2267; E02F 3/425; E02F 9/2285; E02F 9/2228; F15B 2211/20576; F15B 2211/31582; E02F 3/32

(57) ABSTRACT

A hydraulic drive system of a construction machine includes: a first hydraulic pump and a second hydraulic pump, whose respective tilting angles are adjustable independently of each other; a turning control valve for controlling supply of hydraulic oil to a turning motor; and a boom main control valve and a boom auxiliary control valve each for controlling supply of the hydraulic oil to a boom cylinder. The turning control valve and the boom auxiliary control valve are disposed on a first bleed line, and the boom main control valve is disposed on a second bleed line. A turning operation valve outputs a pilot pressure to the turning control valve, and a boom operation valve outputs a pilot pressure to the boom main control valve. A boom-side regulating valve outputs no pilot pressure to the boom auxiliary control valve when a turning operation and a boom raising operation are performed concurrently.

### TECHNICAL FIELD

The present invention relates to a hydraulic drive system of a construction machine.

### BACKGROUND ART

Construction machines, such as hydraulic excavators and hydraulic cranes, perform various work by means of a hydraulic drive system. For example, Patent Literature 1 discloses a hydraulic drive system 100 of a hydraulic excavator as shown in FIG. 9. The hydraulic drive system 100 includes, as hydraulic actuators, a turning motor 110, an arm cylinder 120, a boom cylinder 130, a bucket cylinder 140, an alternate cylinder 150, a right running motor 160, and a left running motor 170. The hydraulic drive system 100 further includes two hydraulic pumps (a first hydraulic pump and a second hydraulic pump; not shown) that supply hydraulic oil to the hydraulic actuators.

On a first bleed line 101 extending from the first hydraulic pump, a turning control valve 111; an arm main control valve 121; a boom auxiliary control valve 132; an alternate control valve 151; and a left running control valve 171 are sequentially arranged from the upstream side. A first parallel line 103 branches off from the first bleed line 101. The hydraulic oil discharged from the first hydraulic pump is led to each control valve through the parallel line 103.

On a second bleed line 102 extending from the second hydraulic pump, a right running control valve 161; a bucket control valve 141; a boom main control valve 131; and an arm auxiliary control valve 122 are sequentially arranged from the upstream side. A second parallel line 104 branches off from the second bleed line 102. The hydraulic oil discharged from the second hydraulic pump is led to each control valve (except the right running control valve 161) through the parallel line 104.

Generally speaking, since the boom of a construction machine has a large weight, the load pressure of the boom cylinder is significantly great when a boom raising operation is performed. Accordingly, when a boom raising operation and another operation are performed concurrently, there may be a case where a large amount of hydraulic oil flows into a hydraulic actuator whose load pressure is lower, and an insufficient amount of hydraulic oil is supplied to the boom cylinder.

In order to solve such a problem, Patent Literature 2 discloses a technique in which hydraulic oil is preferentially supplied to a boom cylinder when a boom raising operation and another operation are performed concurrently. Patent Literature 2 takes a bucket operation, an arm operation, and a turning operation as examples of this other operation. As a measure that takes account of a case where a boom raising operation and a turning operation are performed concurrently, a variable throttle valve is provided immediately upstream of a turning control valve that controls the supply of the hydraulic oil to a turning motor. The variable throttle valve is configured to move in conjunction with the boom raising operation. As a result of the movement of the variable throttle valve, the hydraulic oil supplied to the turning motor via the turning control valve is limited.

### CITATION LIST

### Patent Literature

PTL 1: Japanese Laid-Open Patent Application Publication No. H11-101183

PTL 2: Japanese Laid-Open Patent Application Publication No. 2009-92214

### SUMMARY OF INVENTION

### Technical Problem

In the hydraulic drive system 100 shown in FIG. 9, it is conceivable to adopt the technique disclosed in Patent Literature 2 as a measure that takes account of a case where a boom raising operation and a turning operation are performed concurrently. Specifically, a variable throttle that moves in conjunction with the boom raising operation may be provided on a branch passage 105 included in the first parallel line 103, the branch passage 105 leading to the turning control valve 111.

However, in such a configuration, the hydraulic oil supplied to the turning motor when the boom raising operation and the turning operation are performed concurrently passes through a reduced opening of the variable throttle. As a result, energy is consumed wastefully.

In view of the above, an object of the present invention is to provide a hydraulic drive system of a construction machine, the hydraulic drive system being capable of supplying a sufficient amount of hydraulic oil to a boom cylinder when a boom raising operation and a turning operation are performed concurrently while suppressing wasteful energy consumption.

### Solution to Problem

In order to solve the above-described problems, the inventors of the present invention conducted a diligent study. As a result of the study, they have found out that when a turning operation and a boom raising operation are performed concurrently, by blocking a supply line from the boom auxiliary control valve to the boom cylinder, one hydraulic pump can be used as a pump dedicated for the turning motor and the other hydraulic pump can be used as a pump dedicated for the boom cylinder. In addition, in this case, the discharge pressures of both the hydraulic pumps can be made different from each other in accordance with load pressures of the respective hydraulic pumps. Accordingly, by performing horsepower control of both the hydraulic pumps independently of each other (independent horsepower control), the amount of hydraulic oil supplied to the turning motor can be set based on horsepower control characteristics of one of the hydraulic pumps, and the amount of hydraulic oil supplied to the boom cylinder can be set based on horsepower control characteristics of the other hydraulic pump. Specifically, in an ordinary hydraulic drive system of a hydraulic excavator, so-called total horsepower control is performed, in which each hydraulic pump is controlled based on its discharge pressure and the discharge pressure of its counterpart hydraulic pump. In this total horse power control, the tilting angles of both the hydraulic pumps are always kept equal to each other. On the other hand, in the independent horsepower control, in which each hydraulic pump is controlled only based on its discharge pressure, i.e., not based on the discharge pressure of its counterpart hydraulic pump, the tilting angles of both the hydraulic pumps are adjustable independently of each other. The present invention has been made from such a technological point of view.

Specifically, a hydraulic drive system of a construction machine according to the present invention includes: a turning motor and a boom cylinder, each of which serves as a hydraulic actuator; a first hydraulic pump and a second hydraulic pump, whose respective tilting angles are adjustable independently of each other, each pump discharging hydraulic oil at a flow rate corresponding to the tilting angle of the pump; a turning control valve for controlling supply of the hydraulic oil to the turning motor, the turning control valve being disposed on a first bleed line extending from the first hydraulic pump; a boom main control valve and a boom auxiliary control valve each for controlling supply of the hydraulic oil to the boom cylinder, the boom main control valve being disposed on a second bleed line extending from the second hydraulic pump, the boom auxiliary control valve being disposed on the first bleed line; a turning operation valve that outputs a pilot pressure to the turning control valve; a boom operation valve that outputs a pilot pressure to the boom main control valve; and a boom-side regulating valve that outputs a pilot pressure to the boom auxiliary control valve in accordance with a boom raising operation when no turning operation is performed, and outputs no pilot pressure to the boom auxiliary control valve when a turning operation and a boom raising operation are performed concurrently.

According to the above configuration, the boom auxiliary control valve does not move when a turning operation and a boom raising operation are performed concurrently. This makes it possible to use the first hydraulic pump as a pump dedicated for the turning motor and use the second hydraulic pump as a pump dedicated for the boom cylinder. This consequently makes it possible to prevent a large amount of hydraulic oil from flowing into one of the turning motor and the boom cylinder whose load pressure is lower. In addition, the tilting angle of the first hydraulic pump and the tilting angle of the second hydraulic pump are adjustable independently of each other. In other words, since independent horsepower control is performed on both the hydraulic pumps, the amount of hydraulic oil supplied to the turning motor and the amount of hydraulic oil supplied to the boom cylinder can be set based on horsepower control characteristics of the first hydraulic pump and horsepower control characteristics of the second hydraulic pump, respectively. This makes it possible to prevent an occurrence of unnecessary pressure loss in a path from the first hydraulic pump to the turning motor and in a path from the second hydraulic pump to the boom cylinder, thereby making it possible to suppress wasteful energy consumption.

The boom-side regulating valve may be a solenoid proportional valve that outputs, to the boom auxiliary control valve, a pilot pressure proportional to the pilot pressure outputted from the boom operation valve when no turning operation is performed. According to this configuration, when no turning operation is performed, the boom auxiliary control valve can be moved in the same manner as the boom main control valve.

The boom-side regulating valve may be a solenoid on-off valve that blocks a pilot line intended for the boom auxiliary control valve when a turning operation and a boom raising operation are performed concurrently. This configuration makes it possible to realize a less expensive system than in a case where a solenoid proportional valve is adopted as the boom-side regulating valve.

The above-described hydraulic drive system of a construction machine may further include: a first regulator that adjusts the tilting angle of the first hydraulic pump based on a discharge pressure of the first hydraulic pump and a power shift pressure; a second regulator that adjusts the tilting angle of the second hydraulic pump based on a discharge pressure of the second hydraulic pump and the power shift pressure; and a solenoid proportional valve that outputs the power shift pressure to the first regulator and the second regulator. According to this configuration, power shift control can be performed on both the first hydraulic pump and the second hydraulic pump by the single solenoid proportional valve.

The above-described hydraulic drive system of a construction machine may further include: a first regulator that adjusts the tilting angle of the first hydraulic pump based on a discharge pressure of the first hydraulic pump and a first power shift pressure; a first solenoid proportional valve that outputs the first power shift pressure to the first regulator, a second regulator that adjusts the tilting angle of the second hydraulic pump based on a discharge pressure of the second hydraulic pump and a second power shift pressure; and a second solenoid proportional valve that outputs the second power shift pressure to the second regulator. According to this configuration, power shift control of the first hydraulic pump and power shift control of the second hydraulic pump can be performed independently of each other.

For example, the above-described hydraulic drive system of a construction machine may further include a controller that, when a turning operation and a boom raising operation are performed concurrently, controls the first solenoid proportional valve in a manner to increase the first power shift pressure such that a discharge flow rate of the first hydraulic pump decreases and controls the second solenoid proportional valve in a manner to decrease the second power shift pressure such that a discharge flow rate of the second hydraulic pump increases.

### Advantageous Effects of Invention

The present invention makes it possible to supply a sufficient amount of hydraulic oil to the boom cylinder when a boom raising operation and a turning operation are performed concurrently while suppressing wasteful energy consumption.

### BRIEF DESCRIPTION OF DRAWINGS

FIG. 1 is a hydraulic circuit diagram of a hydraulic drive system of a construction machine according to Embodiment 1 of the present invention.

FIG. 2 is a side view of a hydraulic excavator, which is one example of the construction machine.

FIG. 3 is a hydraulic circuit diagram showing the configuration of a regulator.

FIG. 4 is a graph showing a relationship between a pilot pressure from an operation valve and a pilot pressure from a solenoid proportional valve serving as a boom-side regulating valve when a turning operation and a boom raising operation are not performed concurrently.

FIG. 5A is a graph showing horsepower control characteristics of a second hydraulic pump of Embodiment 1, and FIG. 5B is a graph showing horsepower control characteristics of a first hydraulic pump of Embodiment 1.

FIG. 6 is a hydraulic circuit diagram of a hydraulic drive system of a construction machine according to Embodiment 2 of the present invention.

FIG. 7A is a graph showing horsepower control characteristics of a second hydraulic pump of Embodiment 2, and FIG. 7B is a graph showing horsepower control characteristics of a first hydraulic pump of Embodiment 2.

FIG. 8 is a hydraulic circuit diagram of a hydraulic drive system of a construction machine according to Embodiment 3 of the present invention.

FIG. 9 is a hydraulic circuit diagram of a hydraulic drive system of a conventional construction machine.

### DESCRIPTION OF EMBODIMENTS

### Embodiment 1

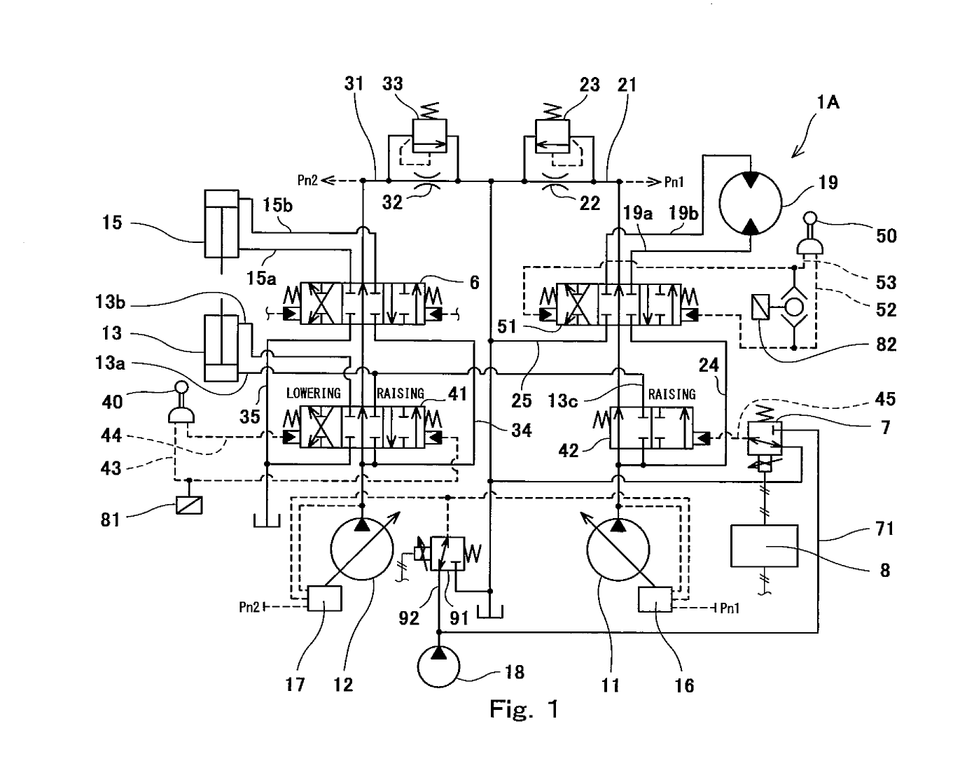

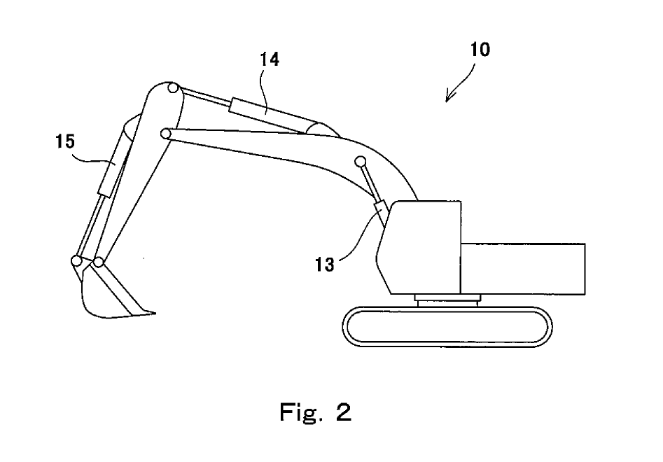

FIG. 1 shows a hydraulic drive system 1A of a construction machine according to Embodiment 1 of the present invention. FIG. 2 shows a construction machine 10, in which the hydraulic drive system 1A is mounted. Although the construction machine 10 shown in FIG. 2 is a hydraulic excavator, the present invention is applicable to any construction machine, so long as the construction machine includes a turning motor and a boom cylinder as hydraulic actuators (e.g., a hydraulic crane).

The hydraulic drive system 1A includes, as hydraulic actuators, a bucket cylinder 15, an arm cylinder 14, and a boom cylinder 13, which are shown in FIG. 2, and also a turning motor 19 (only shown in FIG. 1) and a pair of right and left running motors (not shown). The hydraulic drive system 1A further includes a first hydraulic pump 11 and a second hydraulic pump 12, which supply hydraulic oil to the aforementioned hydraulic actuators. It should be noted that, in FIG. 1, the hydraulic actuators except the bucket cylinder 15, the boom cylinder 13, and the turning motor 19, and control valves intended for some of the hydraulic actuators, are not shown.

The supply of the hydraulic oil to the bucket cylinder 15 is controlled by a bucket control valve 6, and the supply of the hydraulic oil to the turning motor 19 is controlled by a turning control valve 51. Also, the supply of the hydraulic oil to the boom cylinder 13 is controlled by a boom main control valve 41 and a boom auxiliary control valve 42. A first bleed line 21 extends from the first hydraulic pump 11 to a tank, and a second bleed line 31 extends from the second hydraulic pump 12 to the tank. On the first bleed line 21, the boom auxiliary control valve 42 and the turning control valve 51 are disposed in series. On the second bleed line 31, the boom main control valve 41 and the bucket control valve 6 are disposed in series.

Although not illustrated, the supply of the hydraulic oil to the arm cylinder 14 is controlled by an arm main control valve and an arm auxiliary control valve. The arm main control valve is disposed on the first bleed line 21, and the arm auxiliary control valve is disposed on the second bleed line 31. In addition, a pair of running control valves controlling the supply of the hydraulic oil to the pair of right and left running motors is disposed on the first and second bleed lines 21 and 31.

Among the above control valves, only the boom auxiliary control valve 42 is a two-position valve, and the other control valves are three-position valves.

A parallel line 24 branches off from the first bleed line 21. Through the parallel line 24, the hydraulic oil discharged from the first hydraulic pump 11 is led to all the control valves on the first bleed line 21. Similarly, a parallel line 34 branches off from the second bleed line 31. Through the parallel line 34, the hydraulic oil discharged from the second hydraulic pump 12 is led to all the control valves on the second bleed line 31. The control valves on the first bleed line 21 except the boom auxiliary control valve 42 are connected to the tank by a tank line 25, whereas all the control valves on the second bleed line 31 are connected to the tank by a tank line 35.

All the control valves disposed on the first bleed line 21 and the second bleed line 31 are open center valves. That is, when all the control valves on the bleed line (21 or 31) are at their neutral positions, the flow of the hydraulic oil in the bleed line is not restricted by the control valves, and if any of the control valves moves and shifts from its neutral position, the flow of the hydraulic oil in the bleed line is restricted by the control valve.

In the present embodiment, the discharge flow rate of the first hydraulic pump 11 and the discharge flow rate of the second hydraulic pump 12 are controlled by a negative control method. Specifically, the first bleed line 21 is provided with a throttle 22, which is positioned downstream of all the control valves on the first bleed line 21. A relief valve 23 is disposed on a line that bypasses the throttle 22. Similarly, the second bleed line 31 is provided with a throttle 32, which is positioned downstream of all the control valves on the second bleed line 31. A relief valve 33 is disposed on a line that bypasses the throttle 32.

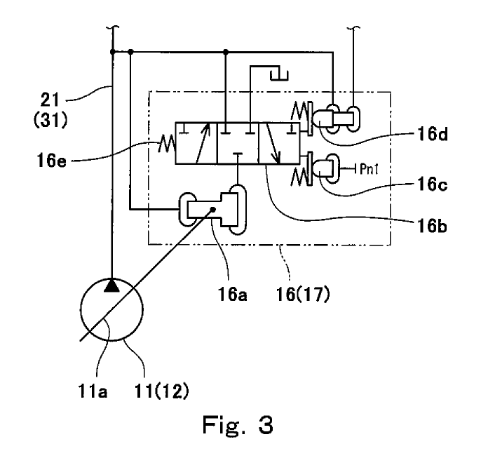

Each of the first hydraulic pump 11 and the second hydraulic pump 12 is driven by an engine that is not shown, and discharges the hydraulic oil at a flow rate corresponding to the tilting angle of the pump and the engine speed. In the present embodiment, swash plate pumps each defining its tilting angle by the angle of a swash plate 11a (see FIG. 3) are adopted as the first hydraulic pump 11 and the second hydraulic pump 12. However, as an alternative, bent axis pumps each defining the tilting angle by the angle of its axis may be adopted as the first hydraulic pump 11 and the second hydraulic pump 12.

The tilting angle of the first hydraulic pump 11 is adjusted by a first regulator 16, and the tilting angle of the second hydraulic pump 12 is adjusted by a second regulator 17. The discharge pressure of the first hydraulic pump 11 is led to the first regulator 16, and the discharge pressure of the second hydraulic pump 12 is led to the second regulator 17. A solenoid proportional valve 91 outputs a power shift pressure to the first regulator 16 and the second regulator 17.

The solenoid proportional valve 91 is connected to an auxiliary pump 18 by a primary pressure line 92, and the auxiliary pump 18 is driven by the aforementioned engine, which is not shown. A controller 8 controls the solenoid proportional valve 91 based on, for example, the speed of the unshown engine. For example, the speed of the engine is divided into a plurality of engine operation regions. The power shift pressure outputted from the solenoid proportional valve 91 is set for each of the engine operation regions.

As shown in FIG. 3, the first regulator 16 includes: a servo cylinder 16a coupled to the swash plate 11a of the first hydraulic pump 11; a spool 16b for controlling the servo cylinder 16a; a spring 16e urging the spool 16b; and a negative control piston 16c and a horsepower control piston 16d, each of which pushes the spool 16b against the urging force of the spring 16e.

The servo cylinder 16a decreases the tilting angle of the first hydraulic pump 11 when the spool 16b is pushed by the negative control piston 16c or the horsepower control piston 16d, and increases the tilting angle of the first hydraulic pump 11 when the spool 16b is moved by the urging force of the spring 16e. The discharge flow rate of the first hydraulic pump 11 decreases in accordance with a decrease in the tilting angle of the first hydraulic pump 11, and the discharge flow rate of the first hydraulic pump 11 increases in accordance with an increase in the tilting angle of the first hydraulic pump 11.

A pressure receiving chamber for causing the negative control piston 16c to push the spool 16b is formed in the first regulator 16. A first negative control pressure Pn1, which is the pressure at the upstream side of the throttle 22 on the first bleed line 21, is led to the pressure receiving chamber of the negative control piston 16c. The first negative control pressure Pn1 is determined by the degree of restriction of the flow of the hydraulic oil by the control valves on the first bleed line 21. When the first negative control pressure Pal increases, the negative control piston 16c advances and thereby the tilting angle of the first hydraulic pump 11 decreases. When the first negative control pressure Pn1 decreases, the negative control piston 16c retreats and thereby the tilting angle of the first hydraulic pump 11 increases.

The horsepower control piston 16d is a piston for adjusting the tilting angle of the first hydraulic pump 11 based on the discharge pressure of the first hydraulic pump 11 and the power shift pressure. To be specific, two pressure receiving chambers for causing the horsepower control piston 16d to push the spool 16b are formed in the first regulator 16. The discharge pressure of the first hydraulic pump 11 and the power shift pressure from the solenoid proportional valve 91 are led to the two pressure receiving chambers of the horsepower control piston 16d, respectively.

It should be noted that the negative control piston 16c and the horsepower control piston 16d are configured such that pushing of the spool 16b by one of these pistons is prioritized over pushing of the spool 16b by the other piston, the one piston restricting (decreasing) the discharge flow rate of the first hydraulic pump 11 to a greater degree than the other piston.

The second regulator 17 is configured in the same manner as the first regulator 16. Specifically, the second regulator 17 adjusts the tilting angle of the second hydraulic pump 12 by the negative control piston 16c based on a second negative control pressure Pn2. The second regulator 17 also adjusts the tilting angle of the second hydraulic pump 12 by the horsepower control piston 16d based on the discharge pressure of the second hydraulic pump 12 and the power shift pressure from the solenoid proportional valve 91.

As described above, the first regulator 16 adjusts the tilting angle of the first hydraulic pump 11 not based on the discharge pressure of the second hydraulic pump 12, and the second regulator 17 adjusts the tilting angle of the second hydraulic pump 12 not based on the discharge pressure of the first hydraulic pump 11. Thus, the tilting angle of the first hydraulic pump 11 and the tilting angle of the second hydraulic pump 12 are adjustable independently of each other.

Returning to FIG. 1, the boom main control valve 41 is connected to the boom cylinder 13 by a boom raising supply line 13a and a boom lowering supply line 13b. The boom auxiliary control valve 42 is connected to the boom raising supply line 13a by an auxiliary supply line 13c.

Pilot ports of the boom main control valve 41 are connected to a boom operation valve 40 by a boom raising pilot line 43 and a boom lowering pilot line 44. The boom operation valve 40 includes an operating lever, and outputs a pilot pressure whose magnitude corresponds to an operating amount of the operating lever to the boom main control valve 41. The boom raising pilot line 43 is provided with a first pressure sensor 81 for detecting the pilot pressure at the time of a boom raising operation.

A pilot port of the boom auxiliary control valve 42 is connected to a boom-side regulating valve 7 by a boom raising pilot line 45. In the present embodiment, the boom-side regulating valve 7 is a solenoid proportional valve. The boom-side regulating valve 7 is connected to the auxiliary pump 18 by a primary pressure line 71.

The turning control valve 51 is connected to the turning motor 19 by a right turning supply line 19a and a left turning supply line 19b. Pilot ports of the turning control valve 51 are connected to a turning operation valve 50 by a right turning pilot line 52 and a left turning pilot line 53. The turning operation valve 50 includes an operating lever, and outputs a pilot pressure whose magnitude corresponds to an operating amount of the operating lever to the turning control valve 51. A turning pilot circuit including the turning pilot lines 52 and 53 is provided with a second pressure sensor 82 for detecting a pilot pressure when a right turning operation or a left turning operation is performed. The second pressure sensor 82 is configured to selectively detect a higher pilot pressure between the pilot pressure of the right turning pilot line 52 and the pilot pressure of the left turning pilot line 53.

The bucket control valve 6 is connected to the bucket cylinder 15 by a bucket-out supply line 15a and a bucket-in supply line 15b. Pilot ports of the bucket control valve 6 are connected to a bucket operation valve (not shown) by a pair of pilot lines.

The above-described boom-side regulating valve 7 is controlled by the controller 8. Specifically, the controller 8 controls the boom-side regulating valve 7 to output a pilot pressure to the boom auxiliary control valve 42 in accordance with a boom raising operation when a turning operation is not performed, and output no pilot pressure to the boom auxiliary control valve 42 when a turning operation and a boom raising operation are performed concurrently.

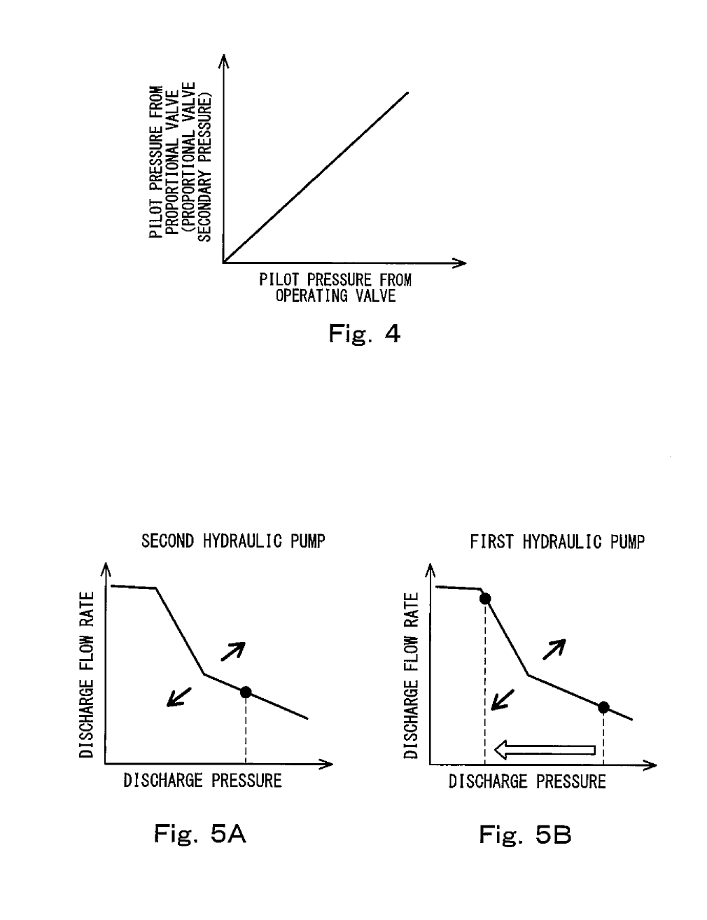

To be more specific, the boom-side regulating valve 7, which is a solenoid proportional valve, allows the boom raising pilot line 45 to be in communication with the tank when no electric current is fed from the controller 8 to the boom-side regulating valve 7. At the time, the boom auxiliary control valve 42 is kept at its neutral position. The controller 8 feeds the boom-side regulating valve 7 with an electric current whose magnitude corresponds to the pilot pressure of the boom raising pilot line 43, the pilot pressure being detected by the first pressure sensor 81, when no turning operation is performed, i.e., when the pilot pressure of the right turning pilot line 52 or the left turning pilot line 53, the pilot pressure being detected by the second pressure sensor 82, is less than a threshold. Accordingly, as shown in FIG. 4, the boom-side regulating valve 7 outputs, to the boom auxiliary control valve 42, a pilot pressure proportional to a pilot pressure outputted from the boom operation valve 40.

On the other hand, when a turning operation and a boom raising operation are performed concurrently, i.e., when the pilot pressure of the boom raising pilot line 43 detected by the first pressure sensor 81 has become higher than or equal to a threshold and the pilot pressure of the right turning pilot line 52 or the left turning pilot line 53 detected by the second pressure sensor 82 has become higher than or equal to a threshold, the controller 8 feeds no electric current to the boom-side regulating valve 7. Consequently, the boom auxiliary control valve 42 does not move.

As described above, in the hydraulic drive system 1A according to the present embodiment, the boom auxiliary control valve 42 does not move when a turning operation and a boom raising operation are performed concurrently. This makes it possible to use the first hydraulic pump 11 as a pump dedicated for the turning motor 19 and use the second hydraulic pump 12 as a pump dedicated for the boom cylinder 13. This consequently makes it possible to prevent a large amount of hydraulic oil from flowing into one of the turning motor 19 and the boom cylinder 13 whose load pressure is lower. It should be noted that the term “dedicated” herein is intended to exclude only one of the turning motor 19 and the boom cylinder 13, and is not necessarily intended to exclude the other hydraulic actuators (e.g., the bucket cylinder 15).

In addition, the tilting angle of the first hydraulic pump 11 and the tilting angle of the second hydraulic pump 12 are adjustable independently of each other. In other words, independent horsepower control is performed on both the hydraulic pumps 11 and 12. Therefore, the amount of hydraulic oil supplied to the turning motor 19 and the amount of hydraulic oil supplied to the boom cylinder 13 can be set based on horsepower control characteristics of the first hydraulic pump 11 and horsepower control characteristics of the second hydraulic pump 12, respectively. This makes it possible to prevent an occurrence of unnecessary pressure loss in a path from the first hydraulic pump 11 to the turning motor 19 and in a path from the second hydraulic pump 12 to the boom cylinder 13, thereby making it possible to suppress wasteful energy consumption.

For example, FIG. 5A shows horsepower control characteristics of the second hydraulic pump 12, which are defined by the second regulator 17. FIG. 5B shows horsepower control characteristics of the first hydraulic pump 11, which are defined by the first regulator 16. It should be noted that the first and second regulators 16 and 17 may be configured such that the horsepower control characteristics shown in FIG. 5A and the horsepower control characteristics shown in FIG. 5B both correspond to ½ of the engine output.

When a turning operation and a boom raising operation are performed concurrently, the discharge pressure of the second hydraulic pump 12, which is the load pressure of the boom cylinder 13, is relatively high. Meanwhile, the discharge pressure of the first hydraulic pump 11, which is the load pressure of the turning motor 19, is relatively high in the beginning of turning acceleration; however, the discharge pressure of the first hydraulic pump 11 becomes relatively low in the latter half of the turning acceleration. The discharge flow rate of the second hydraulic pump 12 is set based on the horsepower control characteristics shown in FIG. 5A in accordance with the discharge pressure of the second hydraulic pump 12. On the other hand, the discharge flow rate of the first hydraulic pump 11 transitions in line with the horsepower control characteristics shown in FIG. 5B in accordance with the discharge pressure of the first hydraulic pump 11.

As shown in FIG. 5B, as the turning acceleration advances, the load pressure of the turning motor 19 decreases, and a high flow rate becomes necessary to increase the turning speed. In this respect, in the present embodiment, the discharge flow rate of the first hydraulic pump 11 increases automatically in accordance with a decrease in the discharge pressure of the first hydraulic pump 11 owing to the function of the above-described horsepower control by the first regulator 16. That is, by effectively utilizing the independent horsepower control of the first hydraulic pump 11, the discharge flow rate of the first hydraulic pump 11 can be automatically controlled so that the discharge flow rate will match a necessary flow rate for the turning.

Further, in the present embodiment, since a power shift pressure is outputted from the solenoid proportional valve 91 to the first regulator 16 and the second regulator 17, power shift control can be performed on both the first hydraulic pump 11 and the second hydraulic pump 12 by the single solenoid proportional valve. That is, by changing the power shift pressure, the horsepower control characteristics shown in FIG. 5A and the horsepower control characteristics shown in FIG. 5B can be shifted concurrently as indicated by arrows shown in FIG. 5A and FIG. 5B.

Still further, in the present embodiment, the boom-side regulating valve 7 is a solenoid proportional valve that outputs, to the boom auxiliary control valve 42, a pilot pressure proportional to a pilot pressure outputted from the boom operation valve 40. For this reason, when no turning operation is performed, the boom auxiliary control valve 42 can be moved in the same manner as the boom main control valve 41.

Still further, in the present embodiment, even if an electrical current stops flowing to the boom-side regulating valve 7, which is a solenoid proportional valve, due to a fault in an electrical system, the boom cylinder 13 can be moved at a certain speed since the boom main control valve 41 remains movable.

### Embodiment 2

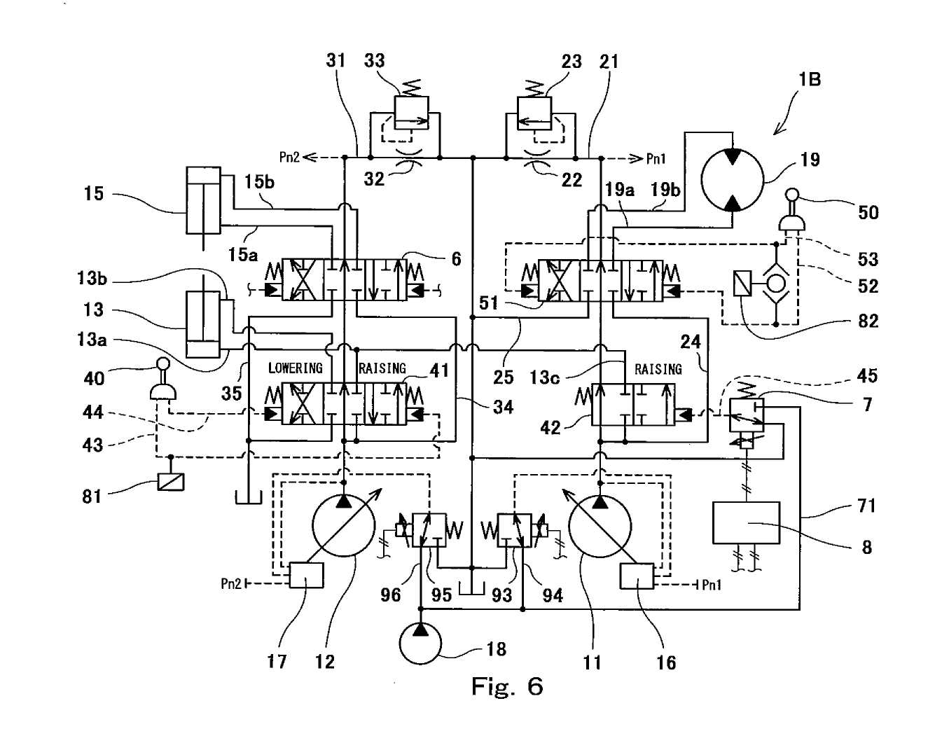

Next, with reference to FIG. 6, a hydraulic drive system 1B of a construction machine according to Embodiment 2 of the present invention is described. It should be noted that, in the present embodiment and Embodiment 3 described below, the same components as those described in Embodiment 1 are denoted by the same reference signs as those used in Embodiment 1, and repeating the same descriptions is avoided below.

In the present embodiment, a first solenoid proportional valve 93 and a second solenoid proportional valve 95 are adopted as solenoid proportional valves for power shift control. The first solenoid proportional valve 93 is connected to the auxiliary pump 18 by a primary pressure line 94, and the second solenoid proportional valve 95 is connected to the auxiliary pump 18 by a primary pressure line 96. The first solenoid proportional valve 93 outputs a first power shift pressure to the first regulator 16, and the second solenoid proportional valve 95 outputs a second power shift pressure to the second regulator 17. Then, the first regulator 16 adjusts the tilting angle of the first hydraulic pump 11 based on the discharge pressure of the first hydraulic pump 11 and the first power shift pressure, and the second regulator 17 adjusts the tilting angle of the second hydraulic pump 12 based on the discharge pressure of the second hydraulic pump 12 and the second power shift pressure.

The present embodiment produces the same advantageous effects as those produced by Embodiment 1. In addition, in the present embodiment, power shift control of the first hydraulic pump 11 and power shift control of the second hydraulic pump 12 can be performed independently of each other. Accordingly, the amount of hydraulic oil supplied to the turning motor 19 and the amount of hydraulic oil supplied to the boom cylinder 13 can be controlled by utilizing the power shift control of the first hydraulic pump 11 and the power shift control of the second hydraulic pump 12, respectively.

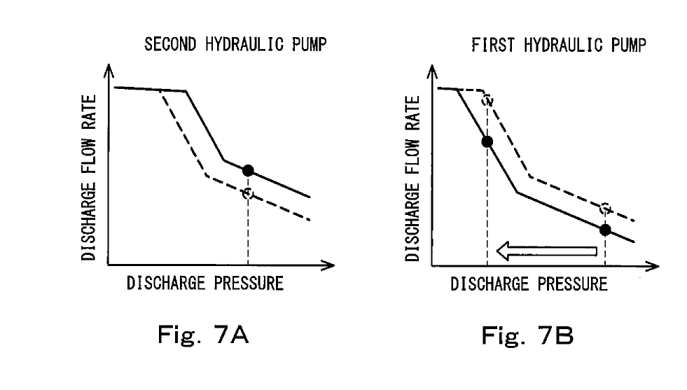

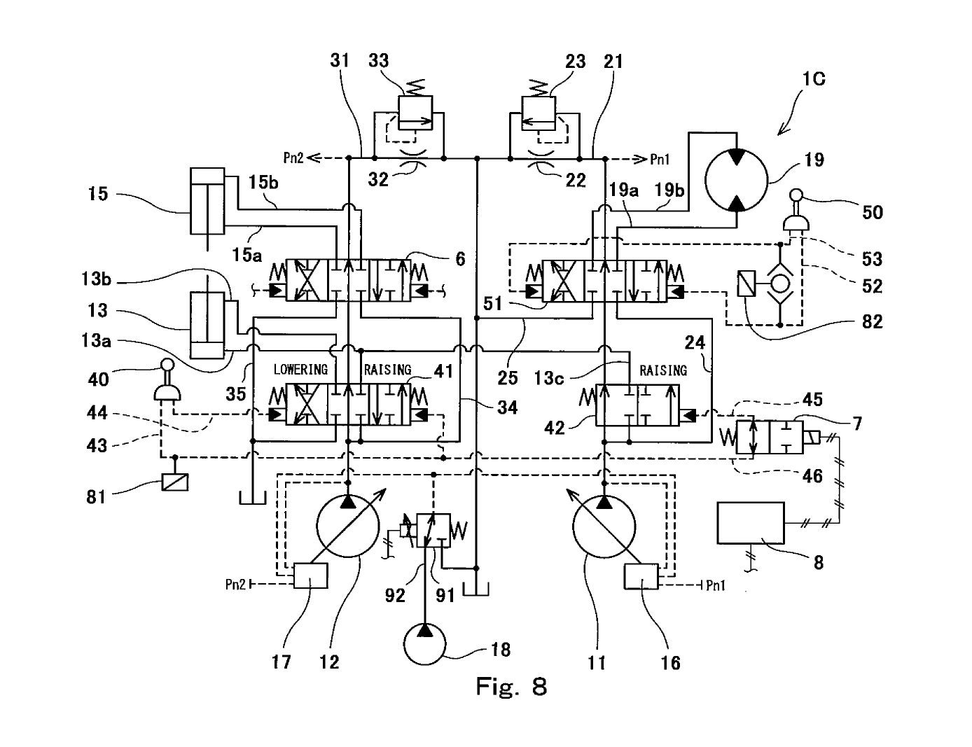

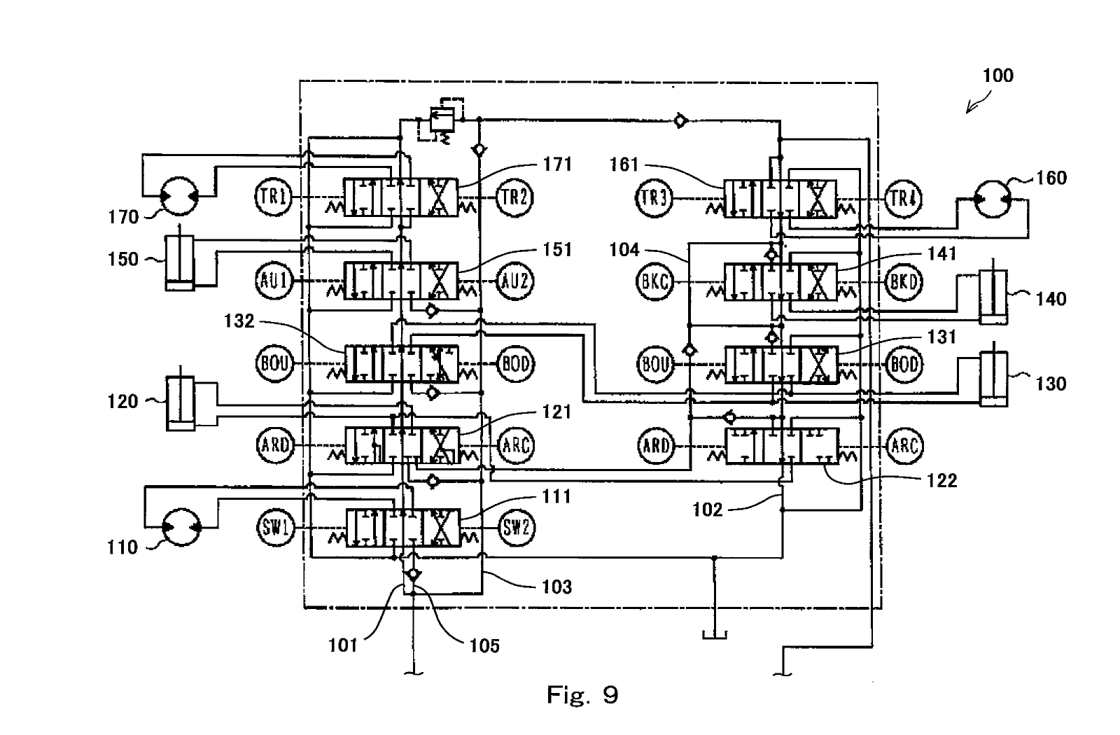

For example, as shown in FIG. 7A and FIG. 7B, when a turning operation and a boom raising operation are performed concurrently, the controller 8 may control the first solenoid proportional valve 93 in a manner to increase the first power shift pressure such that the discharge flow rate of the first hydraulic pump 11 decreases, and may control the second solenoid proportional valve 95 in a manner to decrease the second power shift pressure such that the discharge flow rate of the second hydraulic pump 12 increases.

### Embodiment 3

Next, with reference to FIG. 8, a hydraulic excavator drive system 1C according to Embodiment 3 of the present invention is described. In the present embodiment, a solenoid on-off valve is adopted as the boom-side regulating valve 7. The boom-side regulating valve 7 is connected by a relay line 46 to the boom raising pilot line 43, which extends from the boom operation valve 40 to the pilot port of the boom main control valve 41.

The controller 8 feeds no electric current to the boom-side regulating valve 7, which is a solenoid on-off valve, unless a turning operation and a boom raising operation are performed concurrently. Accordingly, the boom-side regulating valve 7 allows the boom raising pilot line 45 intended for the boom auxiliary control valve 42 to be in communication with the boom raising pilot line 43 intended for the boom main control valve 41 via the relay line 46. That is, the boom-side regulating valve 7 outputs a pilot pressure to the boom auxiliary control valve 42 in accordance with a boom raising operation.

On the other hand, when a turning operation and a boom raising operation are performed concurrently, the controller 8 feeds an electric current to the boom-side regulating valve 7. Accordingly, the boom-side regulating valve 7 blocks the boom raising pilot line 45. That is, the boom-side regulating valve 7 outputs no pilot pressure to the boom auxiliary control valve 42.

The configuration according to the present embodiment makes it possible to realize a less expensive system than in a case where a solenoid proportional valve is adopted as the boom-side regulating valve 7.

Further, in the present embodiment, no pilot pressure is outputted to the boom auxiliary control valve 42 when the boom operation valve 40 is not operated. This makes it possible to prevent erroneous movement of the boom cylinder 13.

It should be noted that, in the hydraulic circuit shown in FIG. 8, a solenoid proportional valve such as one described in Embodiment 1 can be adopted as the boom-side regulating valve 7. Also, similar to Embodiment 2, the first solenoid proportional valve 93, which outputs the first power shift pressure to the first regulator 16, and the second solenoid proportional valve 95, which outputs the second power shift pressure to the second regulator 17, may be adopted in place of the solenoid proportional valve 91, which outputs a power shift pressure to the first regulator 16 and the second regulator 17.

### Other Embodiments

In the above-described Embodiments 1 to 3, the method of controlling the discharge flow rate of each of the first and second hydraulic pumps 11 and 12 need not be a negative control method, but may be a positive control method. That is, each of the first and second regulators 16 and 17 may include a structure that replaces the negative control piston 16c. Moreover, the method of controlling the discharge flow rate of each of the first and second hydraulic pumps 11 and 12 may be a load-sensing method.

### INDUSTRIAL APPLICABILITY

The hydraulic drive system according to the present invention is useful for various construction machines.

### REFERENCE SIGNS LIST

1A to 1C hydraulic drive system
10 construction machine
11 first hydraulic pump
12 second hydraulic pump
13 boom cylinder
16 first regulator
17 second regulator
19 turning motor
21 first bleed line
31 second bleed line
40 boom operation valve
41 boom main control valve
42 boom auxiliary control valve
50 turning operation valve
51 turning control valve
7 boom-side regulating valve
8 controller
91 solenoid proportional valve
93 first solenoid proportional valve
95 second solenoid proportional valve

1. A hydraulic drive system of a construction machine, comprising:
a turning motor and a boom cylinder, each of which serves as a hydraulic actuator;
a first hydraulic pump and a second hydraulic pump, whose respective tilting angles are adjustable independently of each other, each pump discharging hydraulic oil at a flow rate corresponding to the tilting angle of the pump;
a turning control valve for controlling supply of the hydraulic oil to the turning motor, the turning control valve being disposed on a first bleed line extending from the first hydraulic pump;
a boom main control valve and a boom auxiliary control valve each for controlling supply of the hydraulic oil to the boom cylinder, the boom main control valve being disposed on a second bleed line extending from the second hydraulic pump, the boom auxiliary control valve being disposed on the first bleed line;
a turning operation valve that outputs a pilot pressure to the turning control valve;
a boom operation valve that outputs a pilot pressure to the boom main control valve; and
a boom-side regulating valve that outputs a pilot pressure to the boom auxiliary control valve in accordance with a boom raising operation when no turning operation is performed, and outputs no pilot pressure to the boom auxiliary control valve when a turning operation and a boom raising operation are performed concurrently.

2. The hydraulic drive system of a construction machine according to claim 1, wherein
the boom-side regulating valve is a solenoid proportional valve that outputs, to the boom auxiliary control valve, a pilot pressure proportional to the pilot pressure outputted from the boom operation valve when no turning operation is performed.

3. The hydraulic drive system of a construction machine according to claim 1, wherein
the boom-side regulating valve is a solenoid on-off valve that blocks a pilot line intended for the boom auxiliary control valve when a turning operation and a boom raising operation are performed concurrently.

4. The hydraulic drive system of a construction machine according to claim 1, further comprising:
a first regulator that adjusts the tilting angle of the first hydraulic pump based on a discharge pressure of the first hydraulic pump and a power shift pressure;
a second regulator that adjusts the tilting angle of the second hydraulic pump based on a discharge pressure of the second hydraulic pump and the power shift pressure; and
a solenoid proportional valve that outputs the power shift pressure to the first regulator and the second regulator.

5. The hydraulic drive system of a construction machine according to claim 1, further comprising:
a first regulator that adjusts the tilting angle of the first hydraulic pump based on a discharge pressure of the first hydraulic pump and a first power shift pressure;
a first solenoid proportional valve that outputs the first power shift pressure to the first regulator;
a second regulator that adjusts the tilting angle of the second hydraulic pump based on a discharge pressure of the second hydraulic pump and a second power shift pressure; and
a second solenoid proportional valve that outputs the second power shift pressure to the second regulator.

6. The hydraulic drive system of a construction machine according to claim 5, further comprising a controller that, when a turning operation and a boom raising operation are performed concurrently, controls the first solenoid proportional valve in a manner to increase the first power shift pressure such that a discharge flow rate of the first hydraulic pump decreases, and controls the second solenoid proportional valve in a manner to decrease the second power shift pressure such that a discharge flow rate of the second hydraulic pump increases.

7. The hydraulic drive system of a construction machine according to claim 2, further comprising:
a first regulator that adjusts the tilting angle of the first hydraulic pump based on a discharge pressure of the first hydraulic pump and a power shift pressure;
a second regulator that adjusts the tilting angle of the second hydraulic pump based on a discharge pressure of the second hydraulic pump and the power shift pressure; and
a solenoid proportional valve that outputs the power shift pressure to the first regulator and the second regulator.

8. The hydraulic drive system of a construction machine according to claim 3, further comprising:
a first regulator that adjusts the tilting angle of the first hydraulic pump based on a discharge pressure of the first hydraulic pump and a power shift pressure;
a second regulator that adjusts the tilting angle of the second hydraulic pump based on a discharge pressure of the second hydraulic pump and the power shift pressure; and
a solenoid proportional valve that outputs the power shift pressure to the first regulator and the second regulator.

9. The hydraulic drive system of a construction machine according to claim 2, further comprising:
a first regulator that adjusts the tilting angle of the first hydraulic pump based on a discharge pressure of the first hydraulic pump and a first power shift pressure;
a first solenoid proportional valve that outputs the first power shift pressure to the first regulator;
a second regulator that adjusts the tilting angle of the second hydraulic pump based on a discharge pressure of the second hydraulic pump and a second power shift pressure; and
a second solenoid proportional valve that outputs the second power shift pressure to the second regulator.

10. The hydraulic drive system of a construction machine according to claim 3, further comprising:
a first regulator that adjusts the tilting angle of the first hydraulic pump based on a discharge pressure of the first hydraulic pump and a first power shift pressure;
a first solenoid proportional valve that outputs the first power shift pressure to the first regulator;
a second regulator that adjusts the tilting angle of the second hydraulic pump based on a discharge pressure of the second hydraulic pump and a second power shift pressure; and
a second solenoid proportional valve that outputs the second power shift pressure to the second regulator.
